(19) United States
(12) Patent Application Publication
(10) Pub. No.: US 2008/0133925 A1
(43) Pub. Date: Jun. 5, 2008

(54) Signature Assigning Method, Information Processing Apparatus and Signature Assigning Program

(76) Inventors: AKIYA ABE, Yokohama (JP); Kojiro Nakayama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/848,306

(22) Filed: Aug. 31, 2007

(30) Foreign Application Priority Data
Nov. 30, 2006 (JP) 2006-324672

(51) Int. Cl. H04L 9/32; H04L 9/30

(52) U.S. Cl. 713/176

(57) ABSTRACT

A signature object extraction module of computer A extracts, from a message including a plurality of document elements constituting a structured document read from a storage, a signature object including document elements belonging to a particular namespace. A signature assigning module assigns an electronic signature to the signature object extracted by the extraction module. The assigning module sends the message with electronic signature to computer B. An additional information determination module of computer B receives the message from computer A to determine whether or not additional information belongs to the particular namespace. If the information does not belong to the namespace, an additional information insertion module inserts the additional information in the message. The insertion module sends the message to computer C.

### BACKGROUND OF THE INVENTION

The present invention relates to a signing or signature assigning method, an information processing apparatus, and a signature assigning program in which even if information is added to a message with an electronic signature, it is not required to convert the document structure when the message is used after the signature is assigned thereto.

When a plurality of computers exchange a message via networks, an electronic signature is employed to guarantee integrity of the message. The electronic signature is encrypted information of a signature and guarantees the sender of the message and certifies that the message has not been falsified or changed, by use of a public key encryption method.

When a computer sends a message with electronic signature, the message passes through computers to arrive at a destination computer as its receiver in some cases, for example, as below. First, the computer as the source of the message sends the message to a second computer to relay the message. Next, the second computer receives the message to transfer the message to the computer of the final receiver. In the operation, if the second computer changes the message with electronic signature, the computer of the receiver is unable to validate or verify validity of the electronic signature assigned to the message by the computer of the message source.

JP-A-2005-223390 describes a technique in which by inserting message conversion information in an area of a message with electronic signature other than the area as the signature object or to-be-signed area of the message, there is produced a converted message. It is hence possible to change data, for example, to add a data item to the message or to delete a data item therefrom while keeping validity of the electronic signature.

The Extensible Markup Language (XML) document described in XML is used to provide a standard data format when a plurality of computers exchange a message therebetween. The extensible markup language is one of the markup languages and is recommended by the World Wide Web Consortium (W3C) as an organization for standardization. The W3C recommends an XML signature prescribing the method of assigning a signature to any digital data including the XML document.

There is introduced a concept of a namespace so that each term has a name uniquely determined in the world. The namespace is a concept in which by combining a term with a Uniform Resource Identifier (URI) as a description item to indicate a location of an information resource existing on the internet, the term can be easily referred to while reducing possibility of collision thereof. Since it is troublesome to describe a URI for each tag, an alias is assigned to URIs to use the alias as a prefix in the namespace.

In the method described in JP-A-2005-223390, it is possible to add information to a message with electronic signature. However, to obtain the added document from the received message, it is required to convert the document structure, for example, to carry out SML Stylesheet Language Transformations (XSLT). There hence arises a problem that the electronic signature becomes invalid. This is because the document structure varies between when the signature is put to the message and when the message is used. Due to the document added to the message with a valid signature, designated positions change in the document structure and hence there appears a problem in which an XML Path Language (XPath) cannot be efficiently used. The XPath is a language to designate a particular part of an XML document.

In the circulation of a message such as in a workflow, the amount of information items regarding the additional data becomes large in some cases. It is required to conduct the processing to convert the document structure as many times as the data addition is conducted, which leads to a problem of increase in the conversion information.

### SUMMARY OF THE INVENTION

It is therefore an object of the present invention, which has been devised to solve the problems, to provide a signature assigning method, an information processing apparatus, and a signature assigning program wherein even if information is added to a message with electronic signature, it is not required to convert the document structure of the message when the message is used after the signature is assigned thereto.

To achieve the object, for a message including a plurality of document elements constituting a structured document to which an electronic signature is to be assigned, a signature is assigned only to document elements having a common feature, for example, document elements belonging to a particular namespace. The signature is validated, on the basis of predetermined identification information in the message. Therefore, any document element and any attribute belonging to a namespace other than that of the signature object may be directly added to the document elements to which the signature has been assigned.

According to the present invention, it is therefore possible that information is added to a message with electronic signature while keeping validity of the electronic signature and it is not required to convert the document structure of the message when the message is used after the information is added thereto.

### BRIEF DESCRIPTION OF THE DRAWINGS

FIG. 1 is a block diagram showing a system configuration to which the present invention is applied.

FIG. 2 is a block diagram showing a hardware configuration of each computer of FIG. 1.

FIG. 3 is a diagram showing a system processing flow.

FIG. 4 is a program listing showing an example of a transmission message from computer A.

FIG. 5 is a program listing showing an original XML signature object obtained from the transmission message from computer A.

FIG. 6 is a program listing showing an extraction example of a signature object belonging to a particular namespace.

FIG. 7 is a program listing showing another extraction example of a signature object belonging to a particular namespace.

FIG. 8 is a flowchart showing a processing flow in computer A.

FIG. 9 is a flowchart showing a processing flow of computer B.

FIG. 10 is a program listing showing a transmission message from computer B.

FIG. 11 is a flowchart showing a processing flow of computer C.

FIG. 12 is a block diagram showing another system configuration to which the present invention is applied.

FIG. 13 is a flowchart showing a processing flow of computer B.

FIG. 14 is a program listing showing a transmission message from computer B.

FIG. 15 is a schematic block diagram showing a firm analysis report providing service of a securities firm.

### DESCRIPTION OF THE EMBODIMENTS

Description will now be given of an embodiment of the present invention by referring to the drawings.

In conjunction with the embodiment, description will be given of an example of a message exchange operation using a Simple Object Access Protocol (SOAP). This protocol is based on the Hyper Text Transfer Protocol (HTTP) and is used when a first system calls data and a service existing on a second system. In the description of the embodiment, an XML signature is used as an example. However, the present invention is not limited to the SOAP message, but is applicable to any message using any other structured document. The present invention is not limited to the XML signature, but is applicable to any other electronic signature. Although namespace information used for the signature, a message, and additional information are stored in a storage in the embodiment, these items may also be dynamically generated.

In this connection, “structured document” indicates a document and its form adopting a method in which structure is indicated by assigning a tag to a sentence and includes, for example, a document description language, Standard Generalized Markup Language (SGML). Simplified languages thereof are, for example, the XML and the Hyper Text Markup Language. According to a broad definition, the structured documents also include, for example, a document including sentences described in slips and forms and a document including a combination of images and sentences.

### First Embodiment

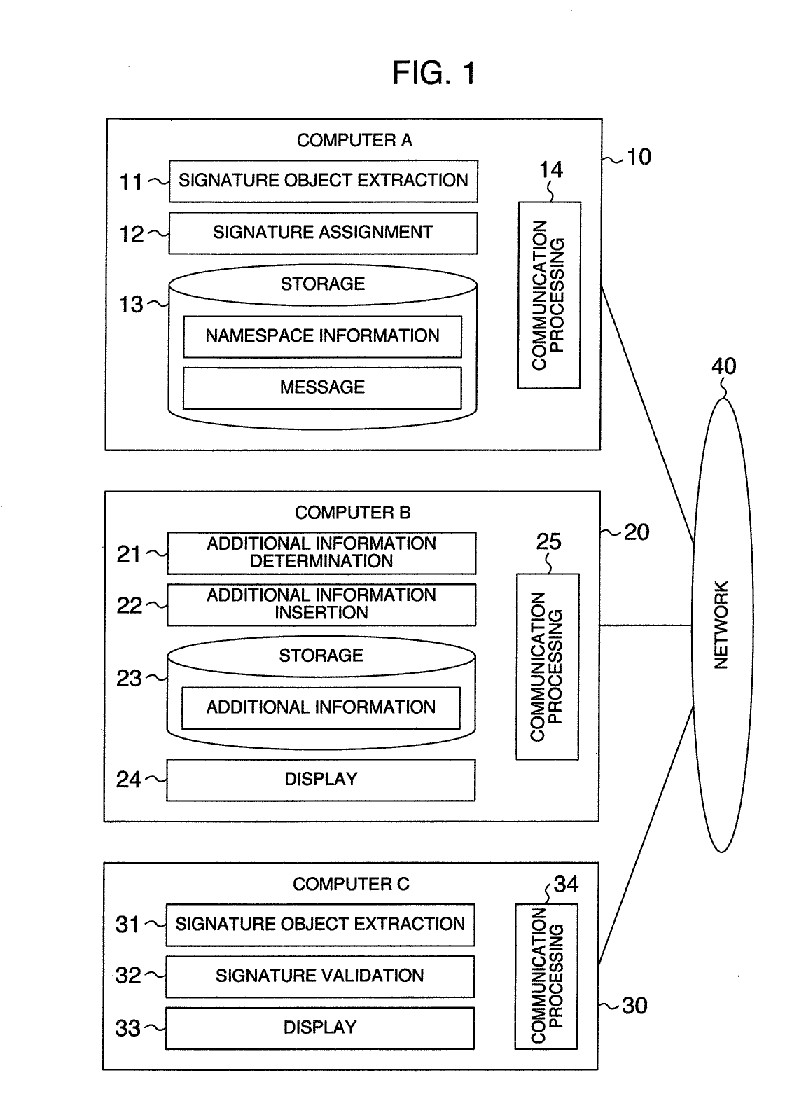

FIG. 1 shows a system configuration to which the present invention is applied. The system of the first embodiment includes computer A (first information processing apparatus or processor) 10, computer B (second information processor) 20, and computer C (third information processor) 30, which are connected via a network 40 to each other.

Computer A 10 is a processor which transmits an SOAP message with XML signature (to be simply referred to as a message hereinbelow) to computer B 20 to send the message to computer C 30. Computer A 10 includes a signature object extraction module 11 to extract, from a message including a plurality of document elements constituting a structured document, a signature object including document elements belonging to a particular namespace; a signature assigning module 12 to assign an XML signature to the extracted signature object, a storage 13 having stored namespace information to be used to assign the signature and a message, i.e., an XML document; and a communication processing or communication module 14 to communicate a message via the network 40 with computers B 20 and C 30.

Computer B 20 is a processor which adds or deletes information to or from a message received from computer A 10 and which transfers the message to computer C 30. Computer B 20 includes an additional information determination module 21 to determine whether or not the additional information belongs to a namespace of the signature object of the message, an additional information insertion module 22 to insert the additional information into the message, a storage 23 having stored the additional information, a display module 24 to output error information to an output device, and a communication module 25 to communicate a message via the network 40 with computers A 10 and C 30.

Computer C 30 is a processor to receive the message via computer B 20 from computer A. Computer C 30 includes a signature object extraction module 31 which extracts, from a message received for signature validation, a signature object including document elements belonging to a particular namespace; a signature validation module 32 to verify validity of an XML signature assigned to the message, a display module 33 to output error information to an output device, and a communication module 34 to communicate a message via the network 40 with computers A 10 and B 20. General computer systems may be used as computers A 10, B 20, and C 30.

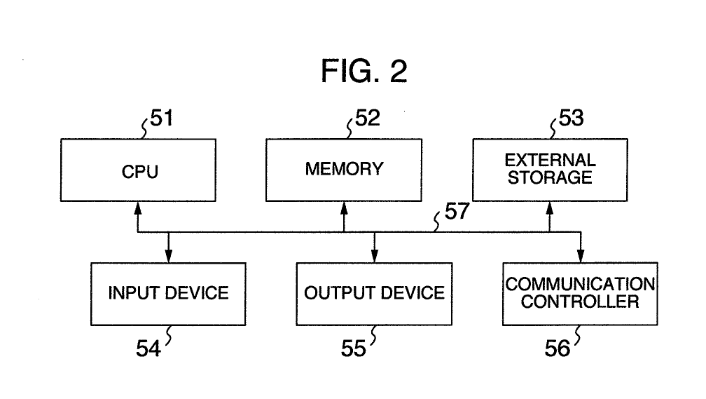

FIG. 2 shows a hardware configuration of each computer shown in FIG. 1. As can be seen from FIG. 2, the computer includes a Central Processing Unit (CPU) 51, a memory 52, an external storage 53 such as a hard disk drive, an input device 54 such as a keyboard and/or a mouse, an output device 55 such as a monitor and/or a printer, a communication controller 56 to connect to a network, and a bus 57 to connect the constituent components to each other. Each function of the respective constituent components is implemented by executing by the CPU 51 an associated program loaded in the memory 52.

Each function of computer A 10 is implemented by executing an associated program by the CPU 51 thereof. This also applies to computers B 20 and C 30. The memory 52 or the external storage 53 of computer A 10 is used as the storage 13 thereof. The memory 52 or the external storage 53 of computer B 20 is used as the storage 23 thereof.

Next, description will be given of a processing flow of the system.

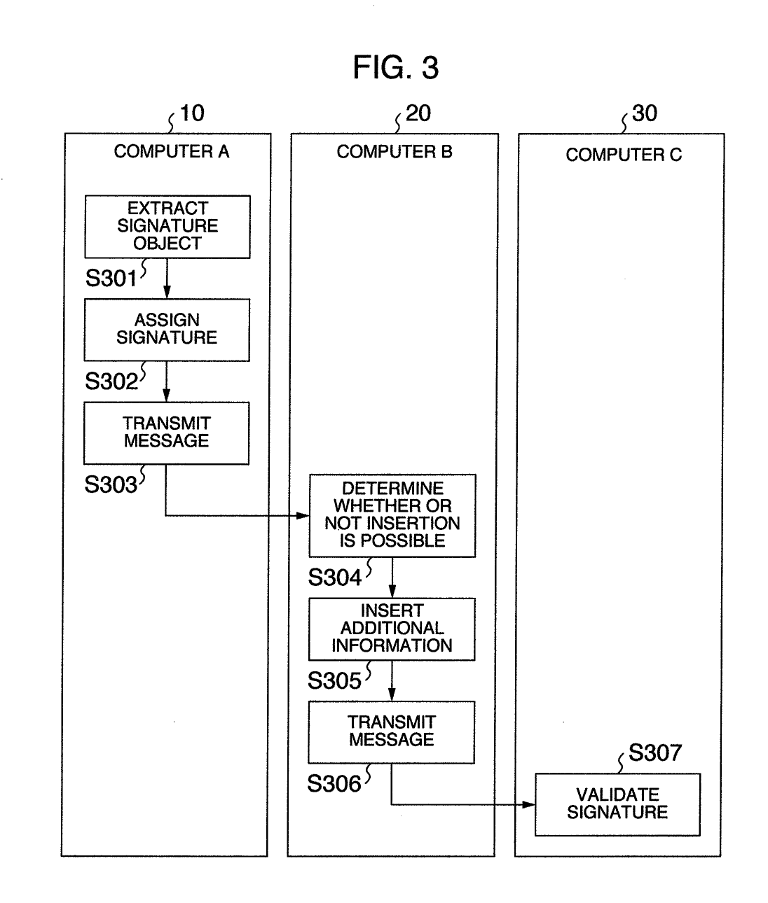

FIG. 3 shows the processing flow of the system. When a signature is requested for a message, the signature object extraction module 11 of computer A 10 extracts, from a message including a plurality of document elements constituting a structured document, i.e., an XML document stored in the storage 13, a signature object including document elements belonging to a particular namespace (S301). The signature assigning module 12 assigns an XML to the signature object (S302). The module 12 then transmits a message with XML signature via the communication module 14 to computer B 20 (S303).

The additional information determination module 21 of computer B 20 receives the message via the communication module 25 from computer A 10 and determines whether or not the additional information obtained from the storage 23 is insertable into the message (S304). If the additional information is insertable as a result of the determination in step S304, the additional information insertion module 22 inserts the additional information in the message (S305). The insertion module 22 sends the message via the communication module 25 to computer C 30 (S306).

The signature validation module 32 of computer C 30 receives the message via the communication module 34 from computer B 20 and verifies the message for validity of the XML signature assigned by computer A 10 (S307).

Description will now be given of the message with XML signature.

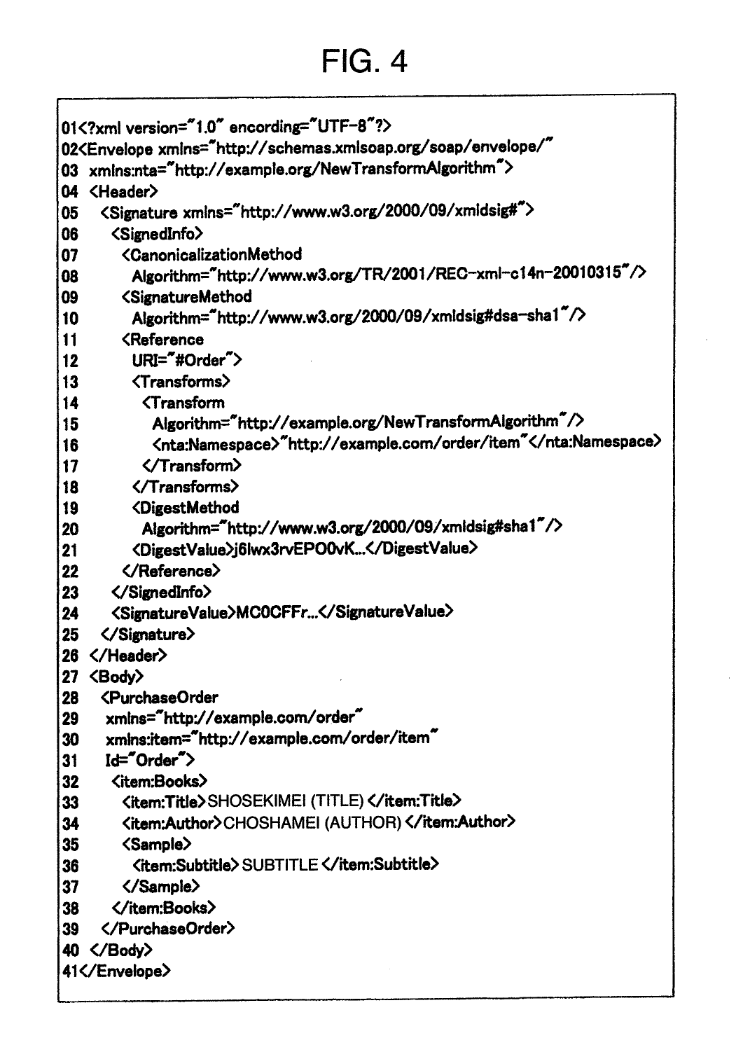

FIG. 4 shows an example of a message transmitted from computer A. Computer A 10 (FIG. 1) assigns an XML signature to the message stored in the storage 13. For easy explanation, the message of FIG. 4 includes a line number (a two-digit numeral at the top of each line), which is not actually included in the listing.

The message includes a root element, i.e., an Envelope element (line numbers 02 to 41). The Envelope element includes child elements, namely, a Header element (line numbers 04 to 26) and a Body element (line numbers 27 to 40).

The Header element describes additional information which an application program to process the message interprets. In the example of FIG. 4, the Header element includes a child element, i.e., a Signature element (line numbers 05 to 25) to describe information regarding the XML signature. The Signature element includes child elements, specifically, a SignedInfo element (line number 06 to 23) and a SignatureValue element (line number 24). The SignedInfo element includes child elements, i.e., a CanonicalizationMethod element (line numbers 07 and 08) to describe a normalization algorithm, a SignatureMethod element (line numbers 09 and 10) to describe a signature value calculation algorithm, and a Reference element (line number 11 to 22) to describe an object of the XML signature. The signature object document designated by “Reference URI=” will be referred to as “original XML signature object” herein below.

In the example shown in FIG. 4, an ID attribute designated by URI=“#Order” described in the Reference element is “Order”. The original XML signature object is a PurchaseOrder element (line numbers 28 to 39) as a child element of a Body element, which will be described later. The Reference element includes child elements, i.e., a Transforms element (line numbers 13 to 18) to describe a signature object creation algorithm, a DigestMethod element (line numbers 19 and 20) to describe a digest value calculation algorithm, and a DigestValue element (line number 21) to describe a digest value.

The Transforms element includes a child element, i.e., a Transform element (line numbers 14 to 17). By describing an algorithm name of the method in the Algorithm attribute of the Transform element, only the document elements belonging to a particular namespace can be extracted as a signature object from the original signature object. Extraction of document elements belonging to a particular namespace will be described later.

The Body element is used to describe the contents of a transmission message to be transmitted. In the example shown in FIG. 4, the Body element includes a PurchaseOrder element as a child element. The PurchaseOrder element includes as a child element a Books element (line numbers 32 to 38) to describe book or bibliographic information. The Books element includes child elements, i.e., a Title element (line number 33) to describe a title of an associated book, an Author element (line number 34) to describe an author of the book, and a Sample element (line numbers 35 to 37). The Sample element includes a Subtitle element (line number 36) to describe a subtitle of the book.

The storage 13 of computer A 10 has stored a message to which an XML signature is to be assigned. That is, the storage 13 has stored the message shown in FIG. 4, i.e., the contents of FIG. 4 excepting the Header element (line numbers 04 to 26).

Next, description will be given of a method of extracting document elements belonging to a particular namespace from the original XML signature object.

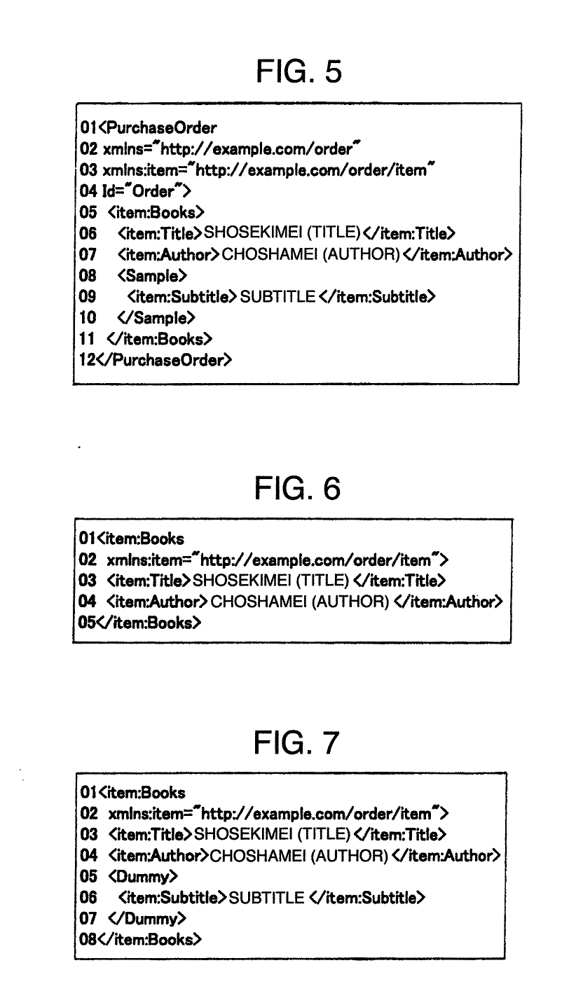

FIG. 5 shows a program listing showing an original XML signature object obtained from a transmission message from computer A. For easy explanation, the message shown in FIG. 5 includes a line number (a two-digit numeral at the top of each line), which is not actually included in the program listing. The original XML signature object includes a PurchaseOrder element (line numbers 01 to 12) as a root element. The PurchaseOrder element includes two space names, i.e., a default namespace “http://example.com/order” and a space name with a prefix “item”, namely, “http://example.com/order/item”. The PurchaseOrder element includes as a child element a Books element (line numbers 05 to 11) to describe bibliographic information. The Books element includes child elements, i.e., a Title element (line number 06) to describe a title of the book, an Author element (line number 07) to describe an author of the book, and a Sample element (line numbers 08 to 10). The Sample element includes a Subtitle element (line number 09) to describe a subtitle of the book.

FIG. 6 shows an example of extraction of a signature object belonging to a particular namespace. For easy explanation, the message of FIG. 6 includes a line number (a two-digit numeral at the top of each line), which is not actually included in the listing. In the example shown in FIG. 6, document elements belonging to a namespace with the prefix “item”, namely, “http://example.com/order/item” are obtained from the original XML signature object and are set as a signature object. A particular namespace is declared for the root element of the signature object elements. The document elements not belonging to the particular namespace as well as the child elements thereof are excluded from the signature object elements. Concretely, the Books element (line numbers 01 to 05), the Title element (line number 03), and the Author element (line number 04) are set as the signature object elements. The specific namespace is declared for the Books element as the root element of the signature object elements (line number 02). The Subtitle element which is a child element of the Sample element not belonging to the specific namespace is excluded from the signature object elements.

FIG. 7 shows another example of extraction of signature object elements belonging to a particular namespace. For easy explanation, the message of FIG. 6 includes a line number (a two-digit numeral at the top of each line), which is not actually included in the listing. In the example shown in FIG. 6, document elements belonging to a namespace with the prefix “item”, namely, “http://example.com/order/item” are obtained from the original XML signature object to be set as signature object elements. A particular namespace is declared for the root element of the signature object elements. For any document element not belonging to the particular namespace, if the document element includes a child element belonging to the particular namespace, its associated text node is deleted and then the element name is replaced by Dummy. Specifically, the Books element (line numbers 01 to 08), the Title element (line number 03), the Author element (line number 04), and the Subtitle element (line number 06) are set as the signature object elements. The specific namespace is declared for the Books element as the root element of the signature object elements (line number 02). For the Sample elements (line numbers 08 and 10 in FIG. 5) including as a child element the Subtitle element (line number 09 in FIG. 5) belonging to the specific namespace, the element names are replaced by Dummy (line numbers 05 and 07).

Next, processing of computer A will be described.

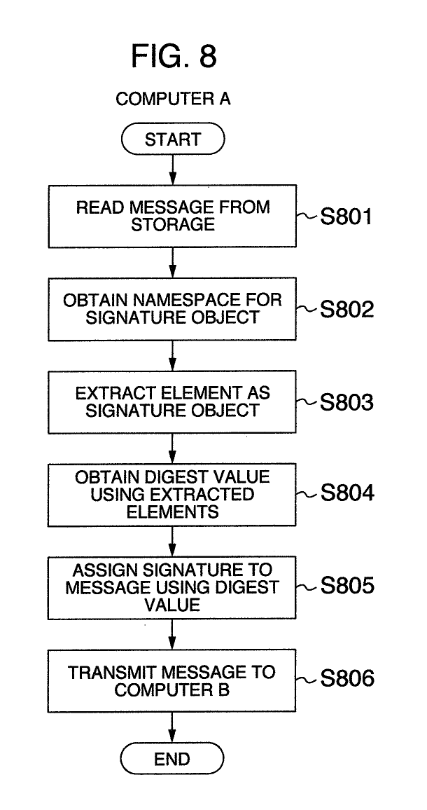

FIG. 8 shows a processing flow of computer A. When a signature is requested form a message, the signature assigning module 12 of computer A 10 reads a message, i.e., an XML document from the storage 13 (S801). The module 12 creates a Signature element to set signature information and adds the element to the header element of the message. The signature object extraction module 11 reads namespace information from the storage 13 to obtain a namespace as a signature object (S802). The namespace is set as a Namespace element which is a child element of the Transform element. Specifically, if the namespace of the signature object is “http://example.com/order/item”, “<nta:Namespace>“http://example.com/order/item“</nta:Na mespace>” is described (line number 16 in FIG. 4). A plurality of Namespace elements may be described. It is hence possible to set a plurality of namespaces as the signature object. The signature object extraction module 11 obtains, from the original XML signature object in the message, document elements belonging to the namespaces obtained in step S802 and sets the document elements as signature object elements (S803).

Specifically, FIG. 6 or 7 is the document element belonging to the particular namespace as the signature object. The signature assigning module 12 obtains, by use of the algorithm set by “DigestMethod Algorithm=” in the Reference element of the message, a digest value (hash value) from the signature object obtained in step S803 (S804). The digest value is set to the DigestValue element. The module 12 normalizes, using the algorithm set by “CanonicalizationMethod Algorithm=”, the Reference element and the SignedInfo element in which the digest value is inserted and then assigns a signature by use of the algorithm set by the SignatureMethod element (S805). The signature value is set to the SignatureValue element. The signature assignment module 12 transmits the message with XML signature via the communication module 14 to computer B (S806).

As above, computer A 10 assigns the XML signature for the message in which only the document elements belonging to the particular namespace are set as the signature object. Therefore, it is possible to add any document element not belonging to the particular namespace to the message while keeping validity of the XML signature assigned by computer A 10.

Next, description will be given of processing by computer B.

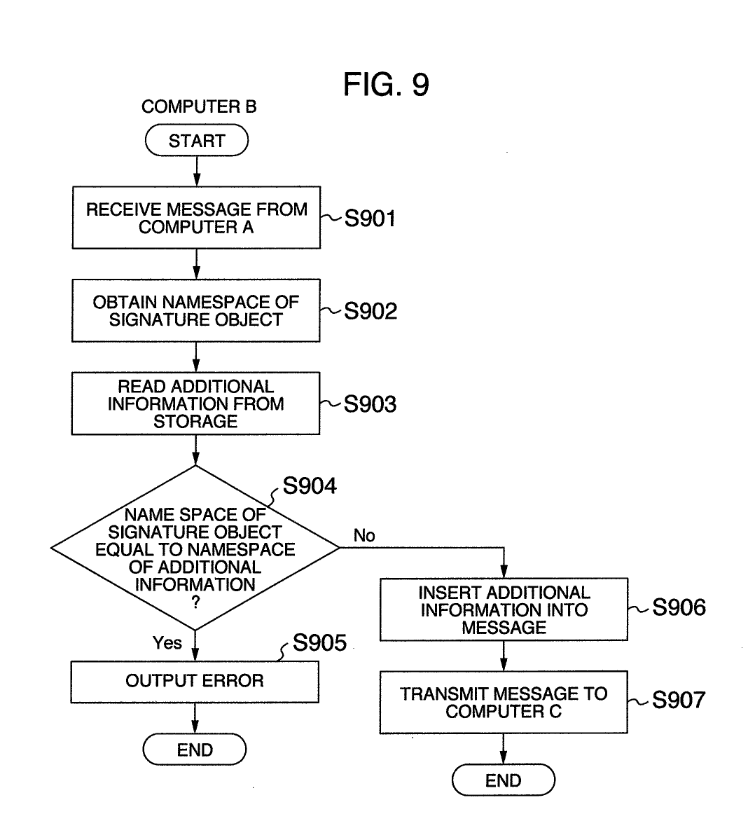

FIG. 9 shows a processing flow of computer B. The additional information determination module 21 receives the message via the communication module 25 from computer A 10 (S901). The module 21 obtains a namespace of the signature object from the message (S902). That is, the module 21 obtains the namespace from the Namespace element as a child element of the Transform element of the message. The module 21 then reads additional information from the storage 23 (S903). Specifically, the additional information is ‘write a book review, insert Comment element belonging to a namespace “http://example.com/order/postscript” in a child element of the Books element.

The additional information determination module 21 compares the namespace to which the additional information obtained in step S903 with that of the signature object to determine whether or not the namespaces are equal to each other (S904). If the namespaces are equal to each other (yes in step S904), the XML signature is destroyed and hence it is not possible to insert the additional information. The display module 24 displays an error message on the output device 55 to indicate that the additional information cannot be inserted (S905). If the namespaces are different from each other (no in step S904), the additional information inserting module 22 obtains the additional information and the message from the additional information determination module 21 to insert the additional information in the message (S906).

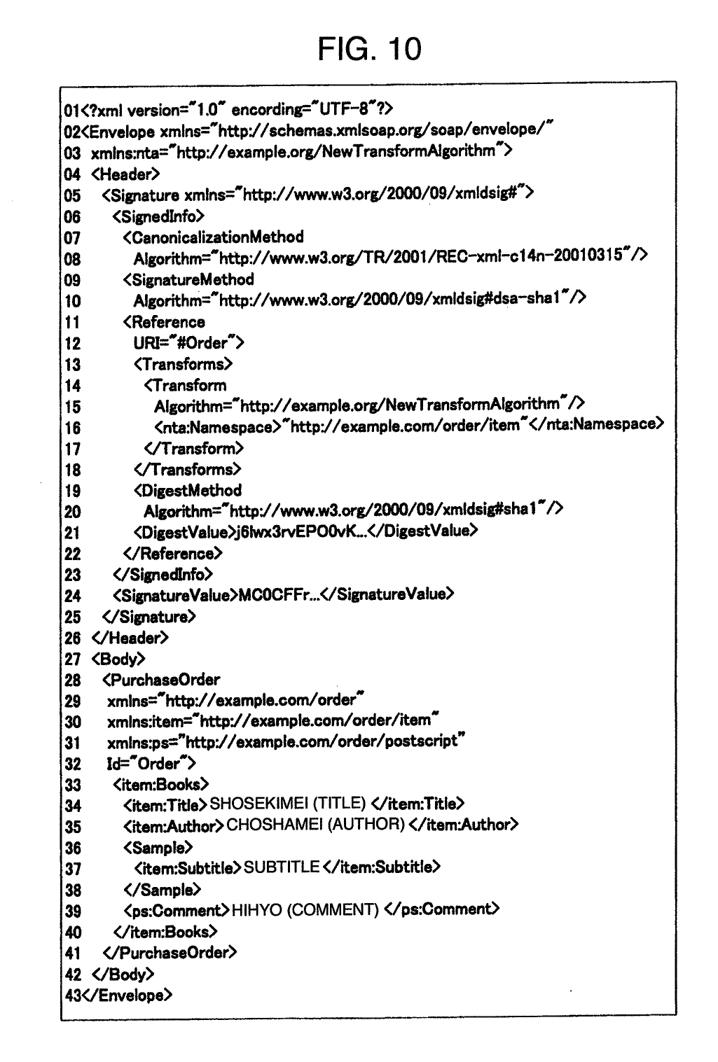

Therefore, the additional information which the inserting module 22 of computer B 20 inserts in the message is not included in the signature object. The module 22 transmits the message with XML signature in which the additional information is inserted via the communication module 25 to computer C 30 (S907). Concretely, the message shown in FIG. 10 is sent to computer C 30.

FIG. 10 shows a transmission message from computer B. The message is obtained by inserting a book review as additional information (line numbers 31 and 39) in the message of FIG. 4 as shown in FIG. 10.

As above, computer B 20 inserts as the additional information the document elements not belonging to the namespace as the signature object in the message. Resultantly, computer B 20 adds the document elements to the message while keeping validity of the XML signature assigned by computer A 10.

Description will now be given of a processing flow of computer C.

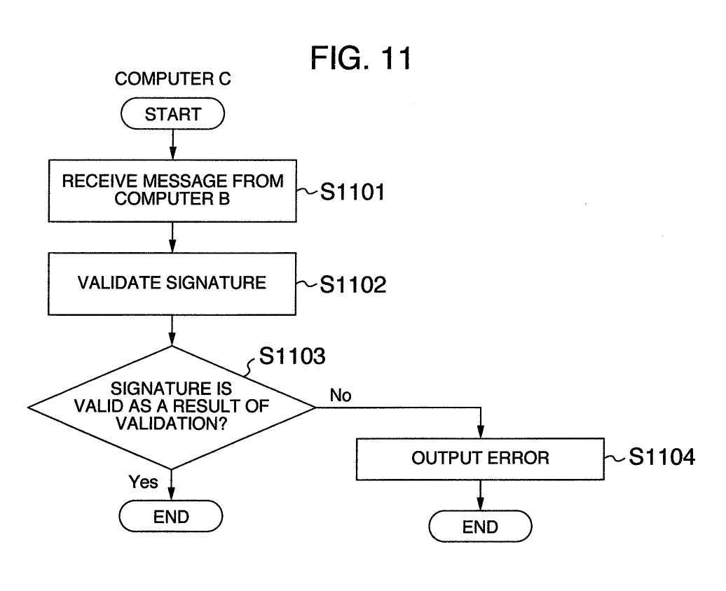

FIG. 11 shows the processing flow of computer C. The signature validation module 32 of computer C 30 receives the message via the communication module 34 from computer B 20 (S1101). The validation module 32 makes a check for validity of the XML signature assigned to the message (S1102). The signer, i.e., the signature assigning module 12 of computer A 10 encrypts, using a private key thereof, a predetermined signature object field of the message (XML document) in the storage 13 to thereby create an XML signature. The module 12 adds the XML signature to the message and sends the message. The signature validation module 32 of computer C 30 decrypts, using a public key of the signer, the XML signature assigned to the message and compares the decrypted result with the signature object field to determine whether or not the XML signature is valid. In the operation, the signature object is obtained by use of the signature object extraction module 31 as described in conjunction with the operation to extract the signature object by the signature object extraction module 11 of computer A 10. By using the XML signature in this way, it can be guaranteed that the message sent from computer A 10 is not changed and that the signer is computer A 10.

In the embodiment, the additional information inserted by the insertion module 22 of computer B 20 is not included in the signature object. Therefore, after the insertion of the additional information by the insertion module 22, the XML signature is kept valid. If the XML signature is invalid as a result of the comparison described above (no in step S1103), the display module 33 displays on the output device 55 an error message indicating that the XML signature is invalid (S1104). If the XML signature is valid as a result of the comparison (yes in step S1103), the display module 33 may output the PurchaseOrder element to the output device 55 to present an addition completion message to the user of computer C 30. Also, the signature validation module 32 may store the addition completion message in the external storage 53.

In this way, computer C 30 validates the XML signature only for the namespace as the signature object. In the verification of validity of the XML signature assigned by computer A 10, it is therefore possible that computer C 30 discriminates any change in the message from the additional information. That is, computer C 30 can appropriately receive the message in which computer B 20 has inserted the additional information.

According to the embodiment, information can be added to a document element of the signature object while keeping validity of the XML signature of computer A 10. It is also possible that computer C 30 first makes a check for validity of the XML signature assigned by computer A 10 and then obtains the message in which computer B 20 has inserted the additional information.

In the embodiment, the first information processor (e.g., computer A) includes a storage 13, a signature object extraction module 11, and a signature assigning module 12. The extraction module 11 extracts, from a message including a plurality of document elements constituting a structured document stored in the storage, a first signature object including document elements (e.g., document elements belonging to a particular namespace) having a shared or common feature on the basis of predetermined identification information in the message. The signature assigning module 12 then is able to assign a signature to the first signature object.

According to the embodiment, the second information processor (e.g., computer B) includes a storage 23, an additional information determination module 21, and an additional information insertion module 22. The determination module 21 makes a check, at reception of the message including a plurality of document elements constituting a structured document with signature from the first information processor, to determine whether or not the additional information obtained from the storage 23 is insertable in the message. If it is determined as a result of the determination that the additional information is insertable, the insertion module 22 may insert the additional information in the message with signature.

### Second Embodiment

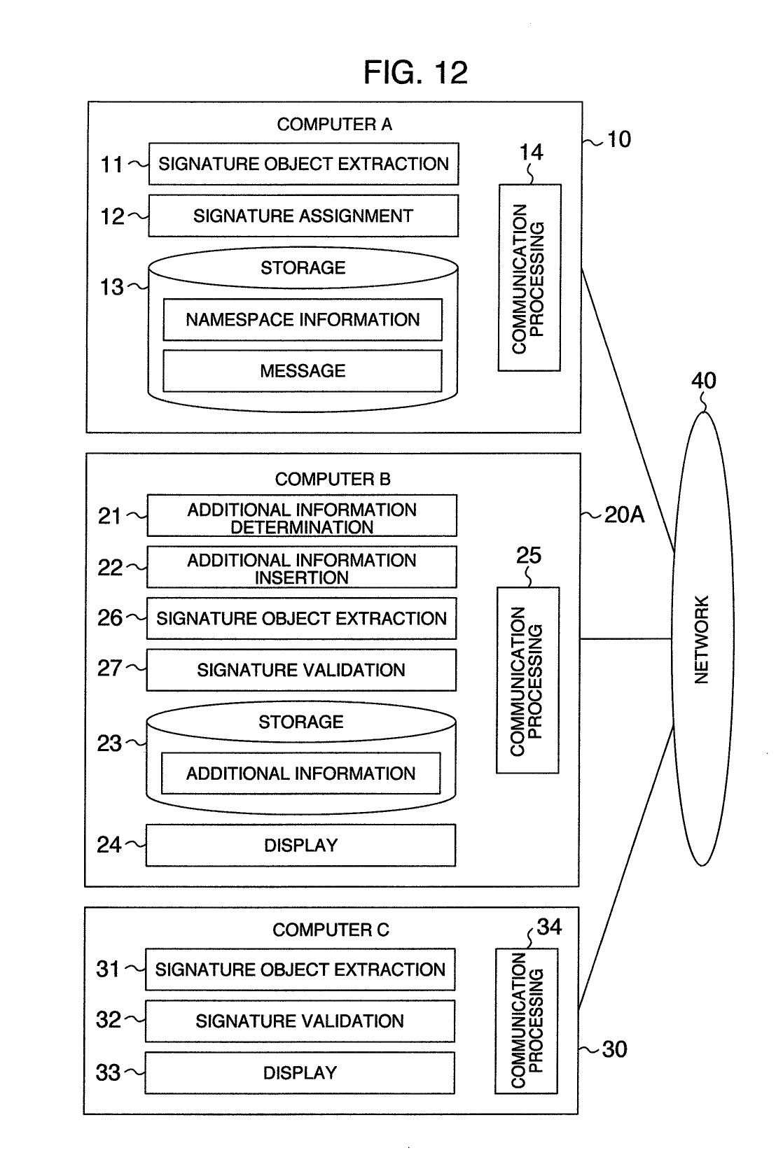

FIG. 12 shows another system configuration in which the present invention is embodied. As FIG. 12 shows, the configuration of computer BA 20A differs from that of computer B 20. In FIG. 12, the same reference numerals are assigned to the same constituent components as those of FIG. 1, and description of such constituent components will be avoided. Computer BA 20A first inserts in the message, additional information including document elements not belonging to the namespace as the signature object and then assigns the XML signature to the additional information as the signature object. Therefore, it is possible that computer BA 20A adds to the message the information to which computer BA 20A assigns the signature while keeping validity of the XML signature assigned by computer A 10.

Computer BA 20A is an apparatus to add information to the message received from computer A 10 and to transfer the message to computer C 30. Computer BA 20A includes an additional information determination module 21 to determine whether or not the additional information belongs to a namespace of the signature object of the message from computer A 10, an additional information insertion module 22 to insert the additional information in the message, a signature object extraction module 26 to extract, from the message in which the additional information is inserted, a signature object including document elements belonging to the namespace of the additional information, a signature assigning module 27 to assign an XML signature to the signature object extracted by the extraction module 26, a storage 23 having stored the additional information, a display module 24 to output error information to an output device, and a communication module 25 to communicate a message via the network 40 with computers A 10 and C 30.

Next, description will be given of processing of computer BA.

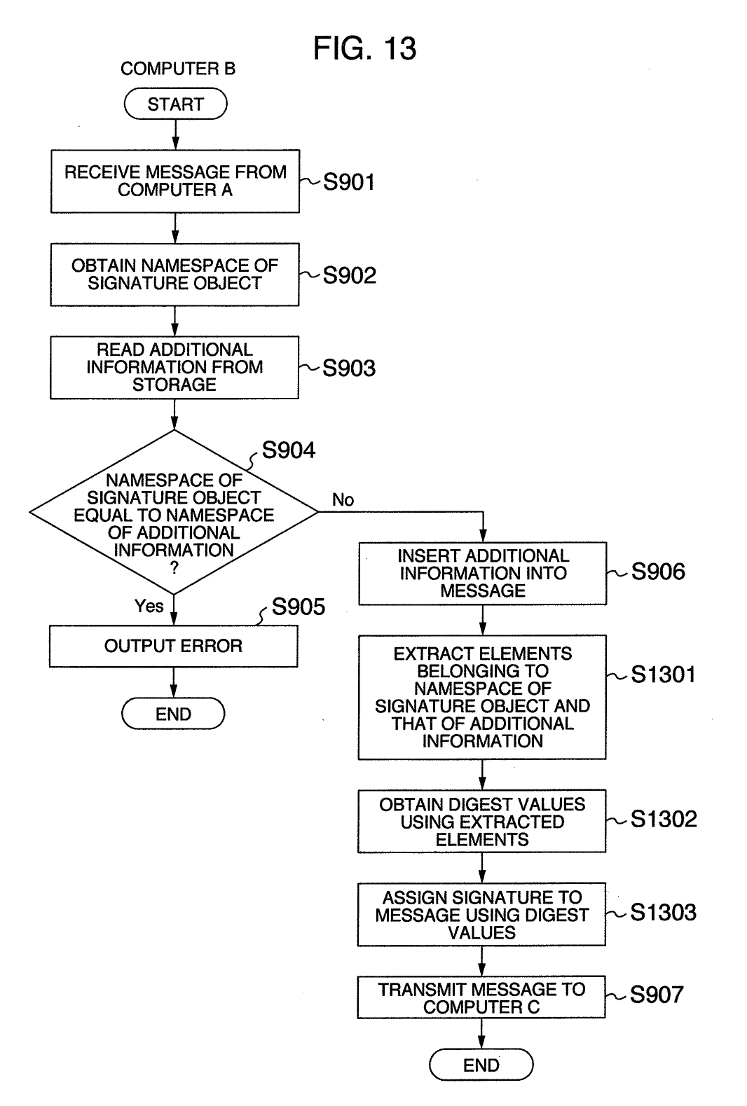

FIG. 13 shows a processing flow of computer BA. The additional information determination module 21 of the computer BA 20A receives a message via the communication module 25 from computer A 10 (S901). The determination module 21 obtains a namespace of the signature object from the message (S902). The module 21 reads the additional information from the storage 23 (S903) and compares the namespace to which the additional information belongs with that of the signature object to determine whether or not the namespaces are substantially equal to each other (S904).

If the namespaces are substantially equal to each other (yes in step S904), the addition of the additional information to the message destroys the XML signature, it is not possible to insert the additional information. The display module 24 hence displays on the output device 55 an error message indicating that the additional information is not possible (S905). If the namespaces are different from each other (no in step S904), the information insertion module 22 obtains the additional information and the message from the determination module 21 to insert the additional information in the message (S906). Therefore, the additional information which the insertion module 22 of computer B 20 inserts in the message is not included in the signature object of computer A 10. The processing (steps S901 to S906) up to this point is almost the same as that shown in FIG. 9.

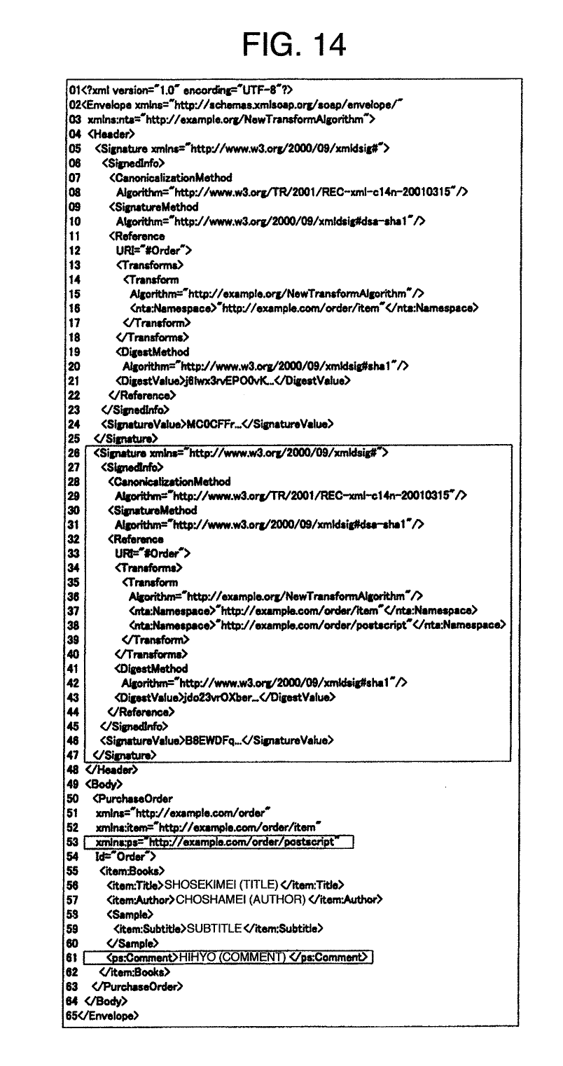

When a signature is requested for the additional information, the signature assigning module 27 creates a Signature element to set signature information and adds the element to the Header element of the message. The signature object extraction module 26 obtains or extracts from the determining module 21 the namespace of the signature object obtained in step S902 and the namespace of the additional information (S1301) and sets the namespaces to Namespace elements in child elements of the Transform element. Description will now be specifically given of the operation by referring to FIG. 14.

FIG. 14 shows a transmission message from computer BA. For easy explanation, the message of FIG. 4 includes a line number (a two-digit numeral at the top of each line), which is not actually included in the listing. The new lines are line numbers 26 to 47 in the Header element and line numbers 53 and 61 in the Body element. If the namespace of the additional information is “http://example.com/order/postscript”, line numbers 37 and 38 are described.

Returning to FIG. 13, like the signature assigning module of computer A 10, the signature assigning module 27 obtains a digest value from the extracted elements (S1302) to assign a signature to the message by use of the digest value (S1303). The assigning module 27 sends the message with XML signature to which the additional information has been added via the communication module 25 to computer C 30 (S907). Specifically, the message shown in FIG. 14 is sent to computer C 30. The message is obtained by inserting the additional information and the signature thereto (the area surrounded by a frame in FIG. 14) into the message of FIG. 4.

As above, computer BA 20A inserts as the additional information the document elements not belonging to the namespace of the signature object into the message and then assigns an XML signature to the additional information as the signature object. Therefore, while keeping validity of the XML signature assigned by computer A 10, it is possible to add to the message the information to which computer B 20 assigns a signature.

In the embodiment, the information processor, e.g., computer BA includes a storage 23, an additional information determination module 21, an additional information insertion module 22, a signature object extraction module 26, and a signature assigning module 27. When a message including a plurality of document elements constituting a structured document is received from a second information processor, e.g., computer A, the determination module 21 makes a check to determine whether or not the additional information obtained from the storage 23 is insertable in the message. If it is determined as a result of the determination that the additional information is insertable, the insertion module 22 inserts the additional information in the message. The signature object extraction module 26 extracts from the message a signature object including document elements which belong to document elements (such as document elements belonging to a particular namespace) having a shared feature on the basis of predetermined identification information already assigned with a signature and which have a shared feature on the basis of predetermined identification information of the additional information. The signature assigning module 27 is able to assign a signature to the signature object extracted as above.

In the embodiment of the present invention, there is provided a method of adding information in a signature object in which a signature may be assigned to a document element belonging to a particular namespace. The present invention leads to advantages as below.
(1) Since it is not required to convert the structured document, the received message can be easily processed.
(2) Since it is not required to convert the structured document, the validity of the signature of the received message is kept unchanged.
(3) The amount of data to be added is small.
(4) A signature may be assigned to the data added to the message. That is, a plurality of signatures may be assigned.

Description will now be given of an information providing service as a business example in a specific utilization mode of the present invention.

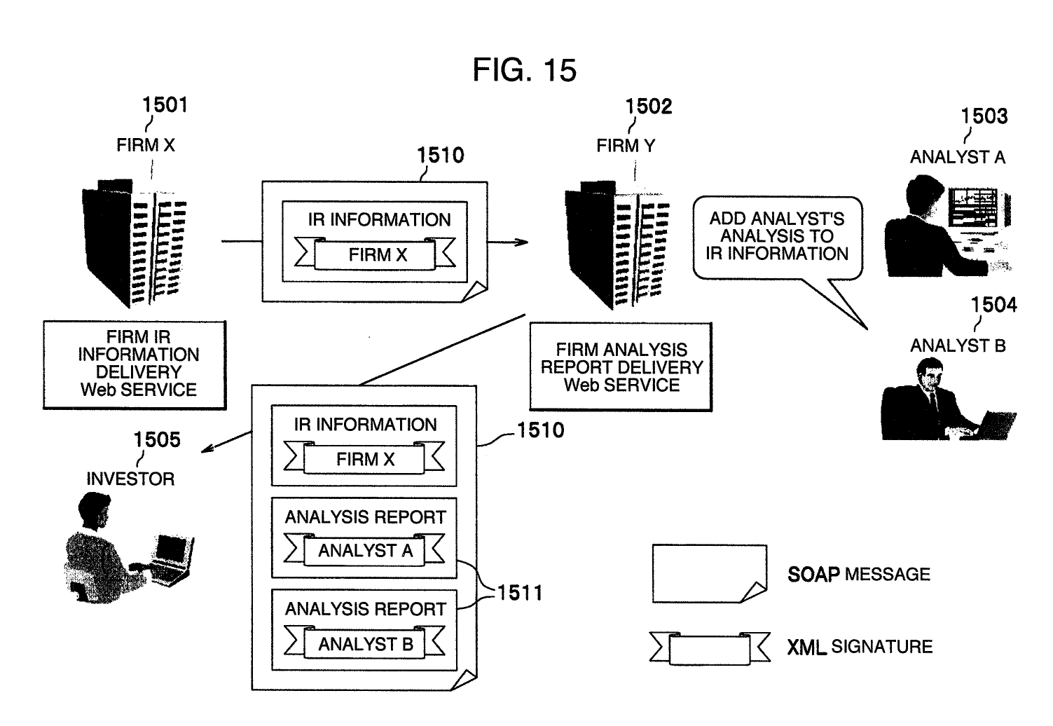

FIG. 15 shows a firm analysis report providing service of a securities firm. Firm X 1501 delivers Investor Relation (IR) information as a web service to investors, securities firms, and the like. The investor relation indicates publicity activities of firms for investors. As a value-added service of the web service for an investor (client) 1505, securities firm Y 1502 delivers IR information with analysis results of analysts A 1503 and B 1504 to the investor 1505. It is possible to add an analysis report 1511 with electronic signatures of the analysts A 1503 and B 1504 to IR information 1510 with an electronic signature of firm X 1501. According to the present invention, there is provided a method of assigning a signature to a message in which even if information is added to a message with electronic signature, it is not required to convert the document structure when the message is used after the electronic signature is assigned.

The present invention is not restricted by the embodiments, but the embodiments may be changed and modified in various ways within the scope of the present invention. For example, the present invention is applicable to, for example, the circulation of a structured document such as an XML document using an electronic workflow. In the system configurations of the embodiments according to the present invention, computers A to C are separated from each other. However, it is also possible that each of the computers connected to the network includes the functional modules of computers A to C, that is, the signature object extraction module, the signature assigning module, the storage, the additional information determination module, the additional information insertion module, and the signature validation module.

1. A signature assigning method for use with an information processing apparatus which provides a message including a plurality of document elements constituting a structured document, the method being used by the apparatus to assign a signature to the message, comprising the steps of:
disposing as the information processing apparatus a first information processing apparatus including a first storage to store the message, a first signature object extraction module, and a first signature assigning module;
extracting by the first signature object extraction module, in response to a request for a signature to the message, a first signature object including document elements having a shared feature on the basis of predetermined identification information in the message from the message stored in the first storage; and
assigning by the first signature assigning module a signature to the first signature object extracted by the first signature object extraction module.

2. A signature assigning method according to claim 1, further comprising the steps of:
disposing as the information processing apparatus a second information processing apparatus including a second storage to store additional information, an additional information determination module, and an additional information insertion module;
making a check by the additional information determination module, at reception of a message with signature from the first information processing apparatus, to determine whether or not the additional information obtained from the second storage is insertable in the message; and
inserting by the additional information insertion module the additional information in the message if it is determined by the additional information determination module that the additional information is insertable in the message.

3. A signature assigning method according to claim 2, further comprising the steps of:
disposing a second signature object extraction module and a second signature assigning module in the second information processing apparatus;
extracting from the message with signature by the second signature object extraction module, in response to a request for a signature to the message, a second signature object including document elements which belong to document elements having a shared feature on the basis of predetermined identification information of the first signature object and which have a shared feature on the basis of predetermined identification information in the additional information; and
assigning by the second signature assigning module a signature to the second signature object extracted by the second signature object extraction module.

4. A signature assigning method for use with an information processing apparatus which provides a message including a plurality of document elements constituting a structured document, the signature assigning method being used by the apparatus to assign a signature to the message using, comprising the steps of:
disposing a storage to store additional information, an additional information determination module, an additional information insertion module, a signature object extraction module, and a signature assigning module in the information processing apparatus;
making a check by the additional information determination module, at reception of a message from one other information processing apparatus, to determine whether or not the additional information obtained from the storage is insertable in the message;
inserting by the additional information insertion module the additional information in the message if it is determined by the additional information determination module that the additional information is insertable in the message;
extracting from the message by the signature object extraction module a signature object including document elements which belong to document elements having a shared feature on the basis of predetermined identification information beforehand assigned with a signature and which have a shared feature on the basis of predetermined identification information as a signature object of the additional information; and
assigning by the signature assigning module a signature to the signature object extracted by the signature object extraction module.

5. A signature assigning method for use with an information processing apparatus which provides a message including a plurality of document elements constituting a structured document, the signature assigning method being used by the apparatus to assign a signature to the message, comprising the steps of:
disposing a first information processing apparatus including a first storage to store the message, a first signature object extraction module, and a first signature assigning module in the information processing apparatus;
extracting from the message stored in the first storage by the first signature object extraction module, in response to a request for a signature to the message, a first signature object including document elements belonging to a particular namespace in the message; and
assigning by the first signature assigning module a signature to the first signature object extracted by the first signature object extraction module.

6. A signature assigning method according to claim 5, further comprising the steps of:
disposing as the information processing apparatus a second information processing apparatus including a second storage to store additional information, an additional information determination module, and an additional information insertion module;
making a check by the additional information determination module, at reception of a message with signature from the first information processing apparatus, to determine whether or not a namespace of the additional information obtained from the second storage is substantially equal to the namespace of the signature object of the message; and
inserting by the additional information insertion module the additional information in the message if it is determined by the additional information determination module that the namespaces are different from each other.

7. A signature assigning method according to claim 6, further comprising the steps of:
disposing a second signature object extraction module and a second signature assigning module in the second information processing apparatus;
extracting from the message with signature by the second signature object extraction module, in response to a request for a signature to the message, a second signature object including document elements which belong to document elements belonging to the namespace of the first signature object and which belong to the namespace of the additional information; and
assigning by the second signature assigning module a signature to the second signature object extracted by the second signature object extraction module.

8. A signature assigning method for use with an information processing apparatus which provides a message including a plurality of document elements constituting a structured document, the signature assigning method being used by the apparatus to assign a signature to the message, comprising the steps of:
disposing a storage to store additional information, an additional information determination module, an additional information insertion module, a signature object extraction module, and a signature assigning module in the information processing apparatus;
making a check by the additional information determination module, at reception of a message from one other information processing apparatus, to determine whether or not a namespace of the additional information obtained from the second storage is substantially equal to a namespace of a signature object of the message;
inserting by the additional information insertion module the additional information in the message if it is determined by the additional information determination module that the namespaces are different from each other;
extracting from the message by the signature object extraction module a signature object including document elements which belong to document elements belonging to a particular namespace beforehand assigned with a signature and which belong to the namespace of the additional information; and
assigning by the signature assigning module a signature to the signature object extracted by the signature object extraction module.

9. An information processing apparatus for assigning a signature to a message including a plurality of document elements constituting a structured document, comprising:
a storage for storing the message to be provided;
a signature object extraction module for extracting from the message stored in the storage a signature object including document elements belonging to a particular namespace in the message; and
a signature assigning module for assigning a signature to the signature object extracted by the signature object extraction module.

10. An information processing apparatus for assigning a signature to a message including a plurality of document elements constituting a structured document, comprising:
a storage for storing additional information;
an additional information determination module for making a check, at reception of a message from one other information processing apparatus, to determine whether or not a namespace of the additional information obtained from the second storage is substantially equal to a namespace of a signature object of the message; and
an additional information insertion module for inserting the additional information in the message if it is determined by the additional information determination module that the namespaces are different from each other.

11. An information processing apparatus according to claim 10, further comprising:
a signature object extraction module for extracting from the message a signature object including document elements which belong to document elements belonging to the namespace of the signature object and which belong to the namespace of the additional information; and
a signature assigning module for assigning a signature to the signature object extracted by the signature object extraction module.

12. An information processing apparatus for assigning a signature to a message including a plurality of document elements constituting a structured document, comprising:
a storage for storing additional information;
an additional information determination module for making a check, at reception of a message from one other information processing apparatus, to determine whether or not a namespace of the additional information is substantially equal to a namespace of a signature object of the message;
an additional information insertion module for inserting the additional information in the message if it is determined by the additional information determination module that the namespaces are different from each other;
a signature object extraction module for extracting from the message a signature object including document elements which belong to a namespace beforehand assigned with a signature and which belong to the namespace of the additional information; and
a signature assigning module for assigning a signature to the signature object extracted by the signature object extraction module.

13. An information processing apparatus according to claim 12, further comprising a signature validation module to conduct validation to determine whether or not the signature of the message received is valid.

14. A signature assigning program for assigning a signature to a message including a plurality of document elements constituting a structured document, the program making a computer execute:
additional information determination processing for making a check, at reception of a message from one other computer, to determine whether or not a namespace of additional information to be added to the message is substantially equal to a namespace of a signature object of the message;
additional information insertion processing for inserting the additional information in the message if it is determined by the additional information determination processing that the namespaces are different from each other;
signature object extraction processing for extracting from the message a signature object including document elements which belong to document elements belonging to a namespace beforehand assigned with a signature and which belong to the namespace of the additional information; and
signature assigning processing for assigning a signature to the signature object extracted by the signature object extraction processing.
